(19) United States
(12) Patent Application Publication
(10) Pub. No.: US 2017/0025800 A1
(43) Pub. Date: Jan. 26, 2017

(54) Extension Cord

(71) Applicants: Charles E. Melino, Jr., Providence, RI (US); Charles E. Melino, Sr., Providence, RI (US)

(72) Inventors: Charles E. Melino, Jr., Providence, RI (US); Charles E. Melino, Sr., Providence, RI (US)

(21) Appl. No.: 15/161,237

(22) Filed: May 21, 2016

Related U.S. Application Data
(60) Provisional application No. 62/165,388, filed on May 22, 2015.

(51) Int. Cl. H01R 24/28; H01R 24/20

(52) U.S. Cl. CPC H01R 24/28; H01R 24/20; H01R 2103/00

(57) ABSTRACT

The present invention is an extension cord comprising a male connector; a female connector; and a body comprising a male end portion connected with the male connector and a female end portion connected with the female connector. The male end portion comprises a first color while the female end portion comprises a second color that is different from the first color. These coloring scheme functions to allow a person to quickly locate the ends and untangle the extension cord.

### CROSS-REFERENCE TO RELATED APPLICATIONS

This application claims priority to U.S. Provisional Application No. 62/165,388 filed on May 22, 2015, now pending, which is hereby incorporated into this specification by reference in its entirety.

### BACKGROUND OF THE INVENTION

Referring to FIGS. 1A and 1B, conventional extension cords have been manufactured and sold for many years with the same color from the male end to the female end along the length of extension cord 10. Such conventional extension cords have several drawbacks. When conventional extension cord 10 becomes tangled with itself (which often occurs between uses) it can be a struggle to untangle because of the fact the entire cord looks the same. This makes it challenging for the user to track down the sections of extension cord 10 that are involved with the tangle.

### SUMMARY OF THE INVENTION

One object of the present invention is to provide an extension cord that is easy to untangle by a person for re-use.

The present invention is an extension cord comprising a male connector; a female connector; and a body comprising a male end portion connected with the male connector and a female end portion connected with the female connector. The male end portion comprises a first color while the female end portion comprises a second color that is different from the first color. These coloring scheme functions to allow a person to quickly locate the ends and untangle the extension cord.

### BRIEF DESCRIPTION OF THE DRAWINGS

The following description of the invention will be more fully understood with reference to the accompanying drawings in which:

FIG. 1A is a perspective view of a conventional extension cord shown entangled with a knot.

FIG. 1B is a close-up view of the knot shown in FIG. 1A.

FIG. 2A is a perspective view of an extension cord according to the present invention shown entangled with a knot.

FIG. 2B is a close-up view of the knot shown in FIG. 2A.

FIG. 3 is a perspective view of the extension cord according to the present invention shown with three sections of the cord separated and untangled with each section being of a different color.

FIG. 4 is a is a perspective view of another embodiment of the extension cord according to the present invention shown with two sections of the cord separated and untangled with each section being of a different color.

### DESCRIPTION OF THE INVENTION

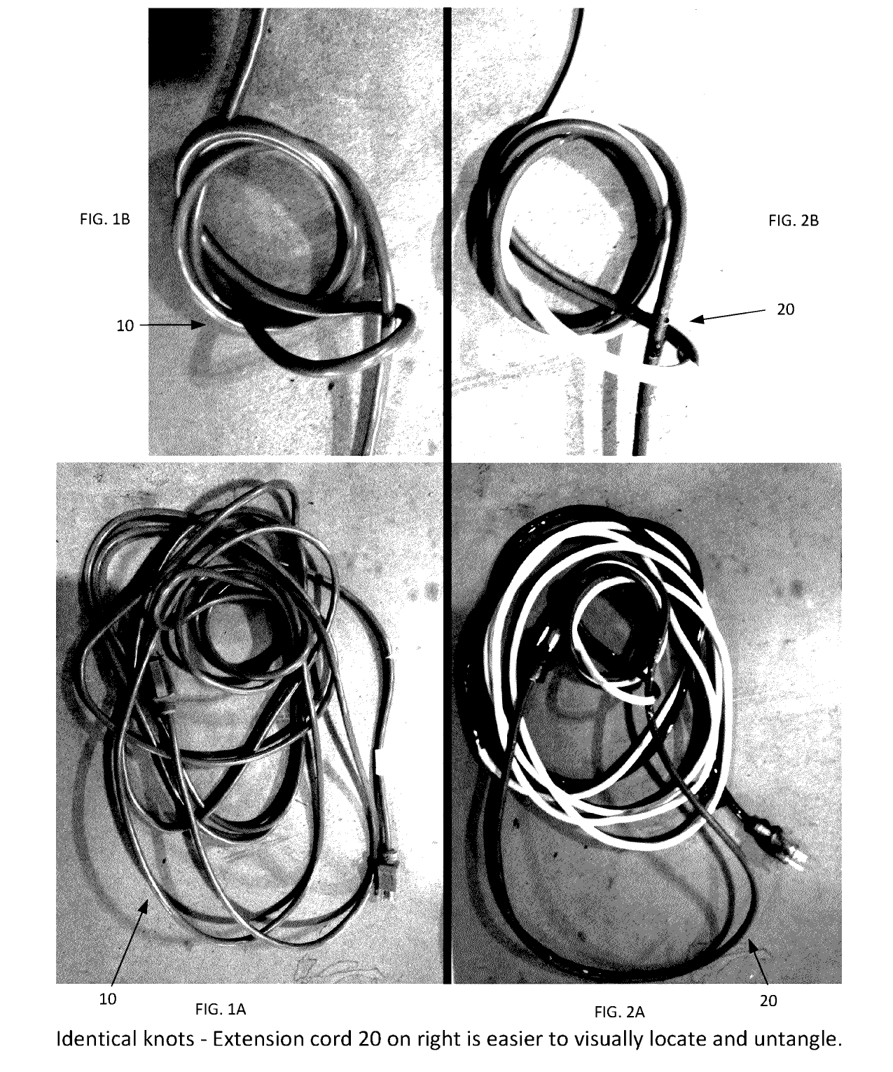

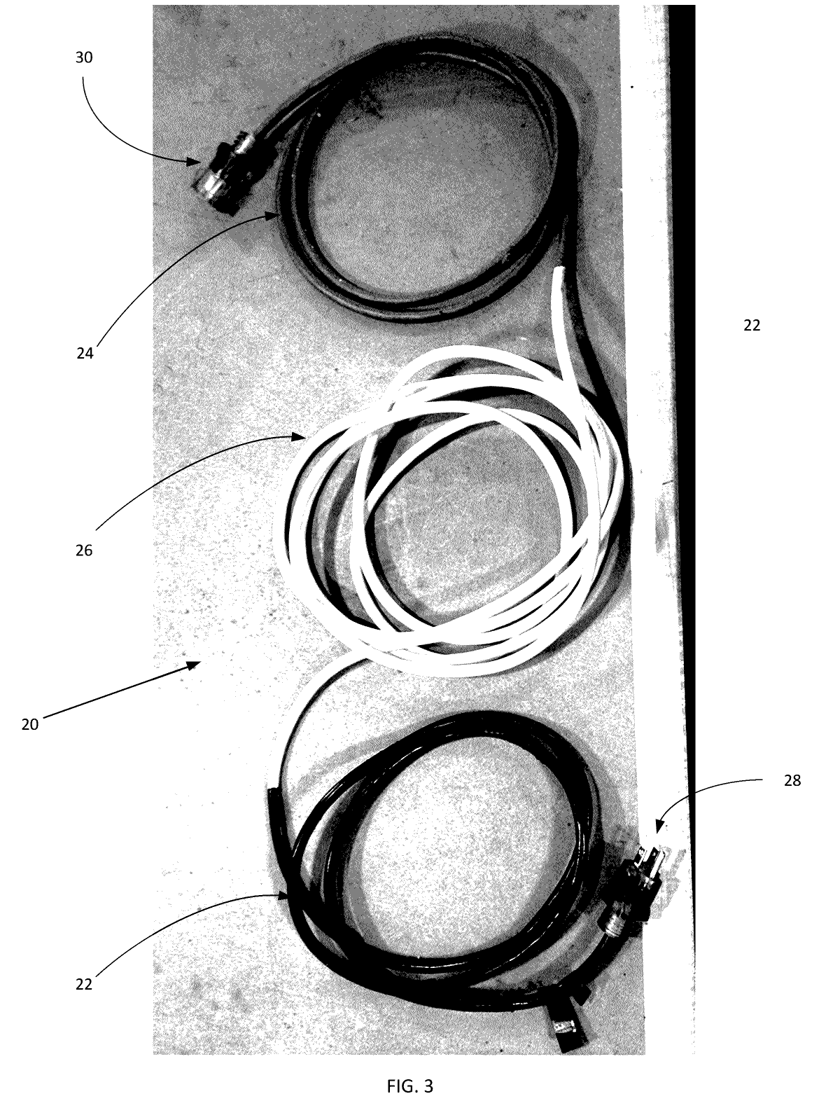

Referring to FIGS. 2A, 2B, and 3, the present invention is an electrical extension cord 20 that eliminates or minimizes the struggle of untangling the cord. Extension cord 20 comprises at least two different colors or visual patterns along its length. FIGS. 2A, 2B, and 2C depict a first embodiment of three colors. As shown, extension cord 20 comprises an elongated body 21 comprising a male end portion or section 22 terminating and connected with a male fitting 28 by conventional means. Male end portion 22 comprises a first color or pattern such as a solid black color. Body 21 further comprises a female end portion or section 24 connected with a female fitting 30 by conventional means. Female end portion 24 comprises a second color or pattern such as a solid orange color. Body 21 further comprises a central or inner portion or section 26 comprising a third color that is different from the first and second colors. By way of example only, the third color may be a solid yellow color. As shown by FIGS. 1B and 2B, unlike conventional extension cord 10, when a tangle occurs in extension cord 20, the user can easily visually identify the sections of extension cord 20 that are feeding or involved in the tangle and is then able to untangle that section with less struggle. The other benefit of the coloring or pattern of extension cord 20 is easier for the user to visually find the ends of the cord for normal usage when no tangles occur. In the embodiment shown, the first color (black) and the third color (orange) are applied to body 21 by paints or dies using conventional means. In the embodiment shown, yellow is the original color of body 21 and the colors black and orange have been applied over that surface. Alternatively, it could be part of body 21 itself.

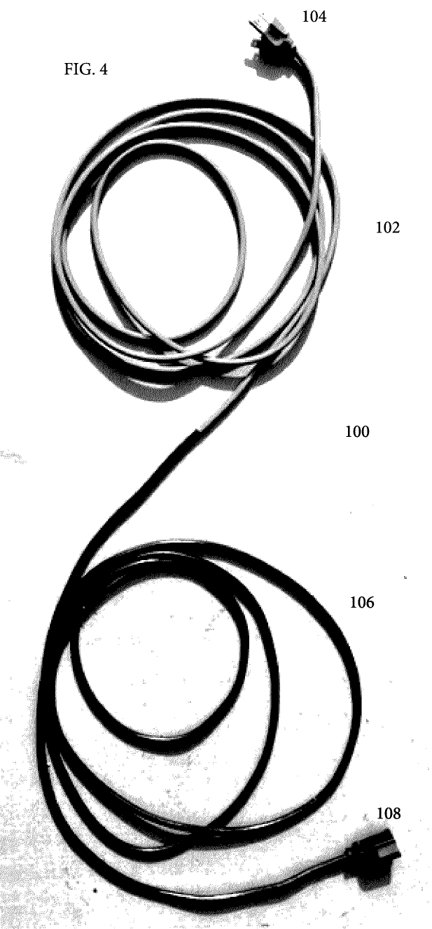

Referring to FIG. 4, where a second embodiment of an extension cord 100 comprises a male end portion or section 102 terminating and connected with a male fitting 104 by conventional means. Male end portion 102 comprises a first color or pattern such as a solid orange color. Extension cord 100 further comprises a female end portion or section 106 connected with a female fitting 108 by conventional means. Section 106 comprises a second color or pattern such as a solid blue color that is different than the color of section 102.

Many different embodiments of the extension cord according to present invention may be fabricated. The number of differing colors or patterns to occur along the length of the extension cord will always be greater than one and is only limited by the length of the individual cord. A short cord less than 8 foot might only have two colors where as a 25 foot cord might have three colors and a 50 foot cord could have five colors.

The above description is intended primarily for purposes of illustration. The invention may be embodied in several other forms or carried out in other ways without departing from the spirit or scope of the invention. Modifications and variations still within the spirit or scope of the invention as claimed will be readily obvious to those of skill in the art.

What is claimed:

1. An extension cord comprising:
a male connector;
a female connector;
a body comprising a first section connected with said male connector and a second section connected with said female connector; said first section comprises a first color; said second section comprises a second color; said first color is different from said second color.

2. The extension cord of claim 1, further comprises a central section disposed between said first and second sections; said central section comprises a third color; said third color is different from said first and said second colors.

3. The extension cord of claim 2, wherein said first color of said first section is black.

4. The extension cord of claim 3, wherein said second color of said second section is orange.
